(19) United States
(12) Patent Application Publication
(10) Pub. No.: US 2015/0092011 A1
(43) Pub. Date: Apr. 2, 2015

(54) Image Controlling Method, Device, and System for Composed-Image Video Conference

(71) Applicant: Huawei Technologies Co., Ltd., Shenzhen (CN)

(72) Inventors: Wuzhou Zhan, Shenzhen (CN); Haibin Wei, Shenzhen (CN); Jiaoli Wu, Shenzhen (CN)

(21) Appl. No.: 14/553,263

(22) Filed: Nov. 25, 2014

Related U.S. Application Data
(63) Continuation of application No. PCT/CN2012/085024, filed on Nov. 22, 2012.

(30) Foreign Application Priority Data
May 25, 2012 (CN) 201210166632.6

(51) Int. Cl. G10L 25/78; H04N 5/262; H04N 7/15

(52) U.S. Cl. CPC G10L 25/78; H04N 7/15; H04N 5/2624; G10L 2025/783
USPC 348/14.08

(57) ABSTRACT

The present invention discloses an image controlling method, device, and system for a composed-image video conference, where the method includes receiving audio data of sites; obtaining, according to audio data of each site of the sites and in real time, a voice feature value that is within a first specified period and of a corresponding site, where the voice feature value is used to represent an activation state of the site; selecting a specified site from the multiple sites according to an activation state of each site; and filling a picture of the specified site into a sub-image of a composed image, to update the composed image in real time. This remarkably improves an effect of a conference, and improves experience of participants. In addition, a quantity and locations of sub-images in the composed image may be further adjusted dynamically, which also effectively improves the effect of the conference.

### CROSS-REFERENCE TO RELATED APPLICATION

This application is a continuation of International Application No. PCT/CN2012/085024, filed on Nov. 22, 2012, which claims priority to Chinese Patent Application No. 201210166632.6, filed on May 25, 2012, both of which are hereby incorporated by reference in their entireties.

### TECHNICAL FIELD

The present invention relates to the videoconferencing field, and in particular, to an image controlling method, device, and system for a composed-image video conference.

### BACKGROUND

In a videoconferencing system, many sites participate in a conference and are located in different places; therefore, in order to enable a participant to communicate face to face with participants at the other sites and to see the participants at the other sites at the same time, a composed-image technology is widely used, where the participant may communicate with participants at multiple sites at the same time by watching a composed image.

Currently, a solution for displaying a composed image by a videoconferencing system is presetting a composed-image mode, such as a 4-image or 9-image mode; then, filling several fixed sites into sub-images of a composed image, where the composed image that is watched at each site during a conference is in the preset mode. During a process of implementing the present invention, the inventor finds that when this solution in the prior art is used, it is possible that no participant speaks at a site in a sub-image, and another site at which participants actively speak is not displayed in the composed image, so that the video conference cannot achieve an expected effect; in addition, in the prior art, a display form of the composed image is fixed, which cannot be adjusted according to on-site conditions.

### SUMMARY

An objective of embodiments of the present invention is to provide an image controlling method, device, and system for a composed-image video conference, to adjust a sub-image according to on-site conditions of each site in real time, thereby effectively improving an effect of a conference.

An embodiment of the present invention discloses an image controlling method for a composed-image video conference, where the method includes receiving audio data of sites; obtaining, according to audio data of each site of the sites and in real time, a voice feature value that is within a first specified period and of a corresponding site, where the voice feature value is used to represent an activation state of the site; selecting a specified site from the sites according to an activation state of each site; and filling a picture of the specified site into a sub-image of a composed image, to update the composed image in real time.

An embodiment of the present invention further discloses an image controlling device for a composed-image video conference, where the device includes an audio receiving unit configured to receive audio data of sites; a voice feature value obtaining unit configured to obtain, according to audio data of each site of the sites and in real time, a voice feature value that is within a first specified period and of a corresponding site, where the voice feature value is used to represent an activation state of the site; a site selecting unit configured to select a specified site from the multiple sites according to an activation state of each site; and a sub-image updating unit configured to fill a picture of the specified site into a sub-image of a composed image, to update the composed image in real time.

An embodiment of the present invention further discloses an image controlling system for a composed-image video conference, where the system includes the foregoing device and one or more site terminals, where the site terminals are configured to display a composed image that is generated under control of the device.

According to the embodiments of the present invention, statistics are collected on a per-period basis; statistics are collected on some feature values that are within the period to determine whether a site is in an activated state, which is used as a basis for participating in synthesis of a composed image, thereby implementing a dynamic adjustment of content of sub-images in the composed image. This remarkably improves an effect of a conference, and significantly improves experience of participants. In addition, according to the embodiments of the present invention, a quantity and locations of sub-images in the composed image may be further adjusted dynamically, which also effectively improves the effect of the conference.

### BRIEF DESCRIPTION OF DRAWINGS

To describe the technical solutions in the embodiments of the present invention more clearly, the following briefly introduces the accompanying drawings required for describing the embodiments. The accompanying drawings in the following description show merely some embodiments of the present invention, and a person of ordinary skill in the art may still derive other drawings from these accompanying drawings without creative efforts.

FIG. 1 is a flowchart of a method according to an embodiment of the present invention;

FIG. 2 is a schematic diagram of audio and video decoding according to an embodiment of the present invention;

FIG. 3 is a schematic diagram of a manner of evenly splitting a composed image according to an embodiment of the present invention;

FIG. 4 is a schematic diagram of a manner of splitting a composed image by embedding a small sub-image in a large sub-image according to an embodiment of the present invention;

FIG. 5 is a schematic diagram of multi-party audio mixing according to an embodiment of the present invention;

FIG. 6 is a schematic diagram of a device according to another embodiment of the present invention; and

FIG. 7 is a schematic diagram of a system according to still another embodiment of the present invention.

### DESCRIPTION OF EMBODIMENTS

The following clearly describes the technical solutions in the embodiments of the present invention with reference to the accompanying drawings in the embodiments of the present invention. The described embodiments are merely a part rather than all of the embodiments of the present invention. All other embodiments obtained by a person of ordinary skill in the art based on the embodiments of the present invention without creative efforts shall fall within the protection scope of the present invention.

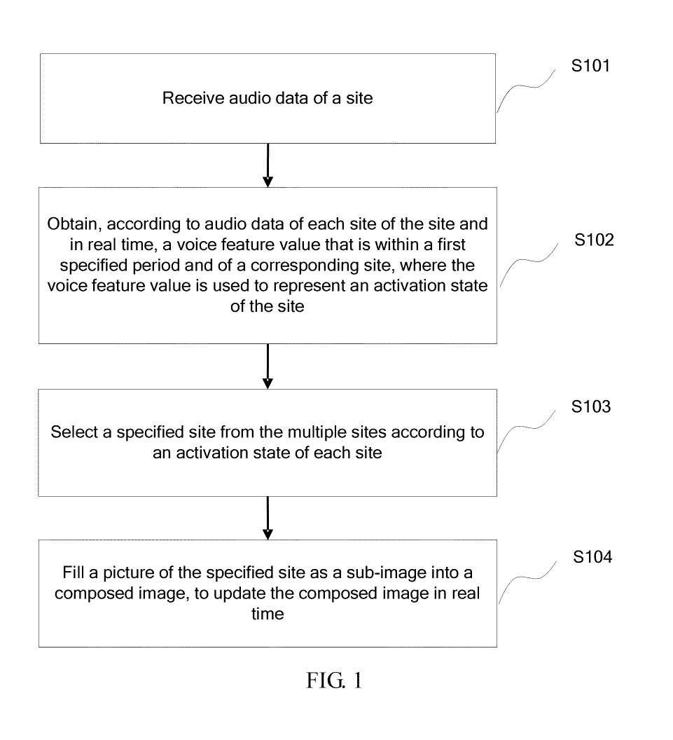

FIG. 1 is a flowchart of a method according to an embodiment of the present invention. The method includes the following steps:

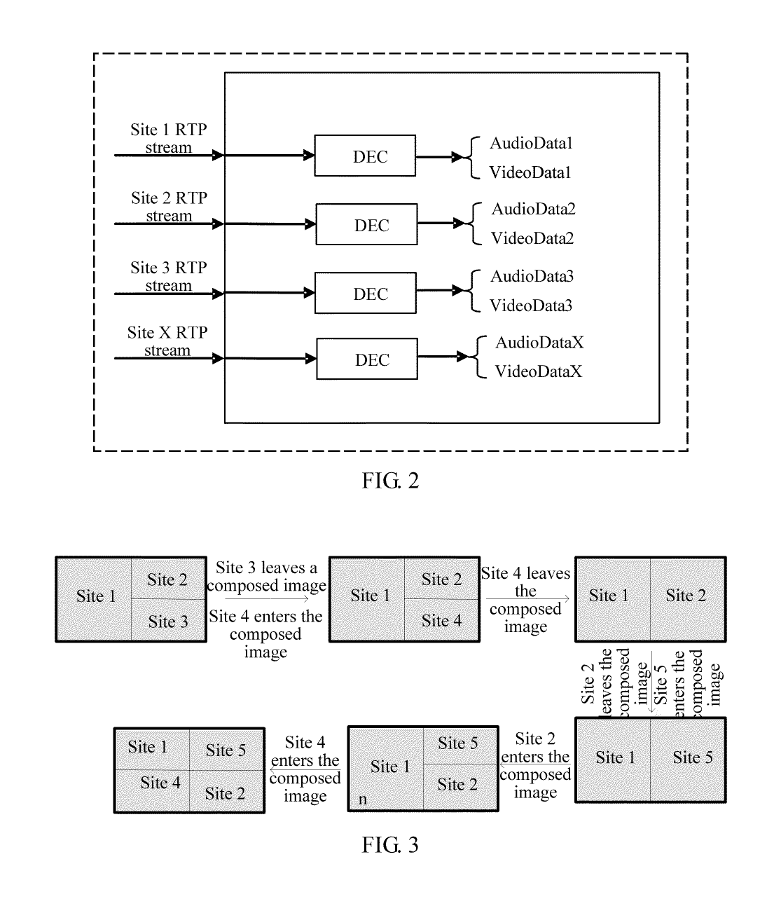

S101: Receive audio data of a site. There may be one or more sites. In this embodiment, a Multipoint Control Unit (MCU) may receive an Real-time Transport Protocol (RTP) stream of each site, and perform decoding according to a corresponding audio and video protocol; after being decoded, an RTP packet is output as an audio and video raw stream. As shown in FIG. 2, a Site in FIG. 2 represents a site; after a Site 1 RTP stream is decoded, audio data is AudioData 1 and video data is VideoData 1; likewise, after a Site X stream is decoded, audio data is AudioData X and video data is VideoData X.

S102: Obtain, according to audio data of each site of the one or more sites and in real time, a voice feature value that is within a first specified period and of a corresponding site, where the voice feature value is used to represent an activation state of the site. A determining criterion is required first to select sites that need to appear in a composed image; in this embodiment, the determining criterion is a voice feature value of each site. If a voice feature value of a site meets a condition, the site may be considered as an activated site, or be referred to as an active site, and may be used as a candidate site for entering the composed image.

In this embodiment, there may be multiple manners of defining and evaluating a voice feature value, which are described below using examples. It should be noted that in other embodiments of the present invention, there may further be multiple other manners of defining and evaluating a voice feature value, which are not limited in this embodiment of the present invention.

Manner 1: Obtain an audio power value that is within the first specified period and of the corresponding site, and use the audio power value as the voice feature value; if the audio power value is greater than a specified power threshold, determine that the site is in an activated state. Preferably, the following two methods may be available for obtaining the audio power value.

The first method is selecting multiple second specified periods within the first specified period, obtaining audio power data of multiple sampling points within each second specified period, obtaining audio power data of a second specified period according to a root mean square value of the audio power data of multiple sampling points, and then using an average value of audio power data of the multiple second specified periods as the audio power value.

T0 (typically, for example, 1 minute) may be used as the first specified period; then a voice feature value of each site within T0 is obtained. Steps of obtaining the voice feature of each site within T0 are for one site, selecting multiple second specified periods T1 (for example, 20 milliseconds) within T0, in other words, T1 is used as a power calculation subunit; then, performing sampling within T1 to obtain multiple pieces of audio power data of the site, for example, performing sampling for N times within one T1, where audio power data obtained by each sampling is x1, x2, . . . , xN, then audio power data xᵣₘₛ of one T1 of the site may be calculated using the following formula:

$${x}_{r m s} = \sqrt{\frac{1}{N} {\sum }_{i = 1}^{N} {x}_{1}^{2}} = \sqrt{\frac{{x}_{1}^{2} + {x}_{2}^{2} + ⋯ + {x}_{N}^{2}}{N}}$$

then, obtaining an average value of all the T1 within T0, and the average value may be used as an audio feature value of T0.

The second method is selecting multiple second specified periods within the first specified period, and then selecting multiple third specified periods within each second specified period; obtaining audio power data of multiple sampling points within each third specified period; obtaining audio power data of a third specified period according to a root mean square value of the audio power data of multiple sampling points; obtaining audio power data of each second specified period according to an average value of audio power data of the multiple third specified periods; and finally, performing weighting on the audio power data of each second specified period and adding the audio power data of each second specified period after the weighting afterwards, and using a result as the audio power value, where a rule of performing the weighting is that a greater weight is closer to a current moment.

The second method is based on the first method, and is extended on the basis of the first method. A difference lies in that in the second method, a longer period T is considered; multiple T0s within T are selected; audio power data of each T0 is obtained using the first method; then, weighting is performed on the audio power data of each T0 and the audio power data of each T0 after the weighting is added afterwards, and a result is used as a final audio power value. The second method is more accurate than the first method because the period (which is extended from T0 to T) considered in the second method is longer.

Manner 2: Collect statistics on a time length in which the corresponding site is in a continuous voice state within the first specified period, and use the time length as the voice feature value; if the time length is greater than a specified time length threshold, determine that the site is in an activated state. Voice Activity Detection (VAD) may be performed to collect statistics on a time length of a continuous voice state within a period T0; the time length is compared with the specified time length threshold; and an activated site is selected according to the time length.

For example, according to VAD detection, time lengths that are accumulated within the period T0 for sites 1, 2, . . . , N is VolTimeLen 1, VolTimeLen 2, . . . , VolTimeLen N, respectively; the VolTimeLens are sorted and compared with one preset time length threshold GateVolTimeLen; and a site whose VolTimeLen is greater than or equal to GateVolTimeLen may be marked as an activated site, and a site whose VolTimeLen is smaller than GateVolTimeLen is marked as an inactive site. Certainly, in other embodiments of the present invention, it is also allowed that no time length threshold is used, and W sites having a longest continuous voice state time length may be selected as activated sites from all the sites.

Manner 3: Obtain an audio power value and a continuous voice state time length that are within the first specified period and of the corresponding site, and use a combination of the audio power value and the time length as the voice feature value; if the combination meets a specified rule, determine that the site is in an activated state. For example, the audio power value may be first used to perform selection, and then the continuous voice state time length is used to perform filtering. Alternatively, one type of value may be used primarily with reference to another value. For example, a site that is of a long voice time length but low audio power may be considered as activated, and a site that is of a short voice time length but high audio power cannot be considered as activated; this may avoid a case that a site is incorrectly determined as an activated site because a participant suddenly knocks a desk or coughs.

S103: Select a specified site from the multiple sites according to an activation state of each site. There may be one or more specified sites. After the activation state of each site is obtained according to the voice feature value, a determining basis is available for determining which sites need to enter the composed image as specified sites.

In this embodiment, there may be multiple manners of selecting specified sites from activated sites and filling the specified sites into the composed image, which are described below using examples. It should be noted that in other embodiments of the present invention, there may further be multiple other selection manners, which are not limited in this embodiment of the present invention.

Manner A: Use a site that is currently in an activated state as the specified site. In other words, all currently activated sites are used as specified sites. This is the simplest to implement.

Manner B: Use both a site that was previously in an activated state and a site that is currently in an activated state as specified sites. This may take historical display into consideration. Currently activated sites are ActiveSite 1, 2, 3, . . . , ActiveSite N respectively, which are recorded in a set CurActiveTabel; activated sites during previous switching are recorded in a set PreActiveTabel; a union portion of site information of the two sets PreActiveTabel and CurActiveTabel is used as sub-image sites of the composed image this time to participate in splicing of the composed image.

Manner C: Use a site that is currently in an activated state, and a site that was previously in an activated state and has a voice feature value greater than a smallest value of a voice feature value of the site that is currently in the activated state, as specified sites. In other words, all currently activated sites participate in splicing of the composed image, and some of previously activated sites may also participate in the splicing of the composed image this time according to voice feature comparison. Among previously activated sites, a site that has a voice feature value smaller than a smallest voice feature value of the currently activated site does not participate in the splicing of the composed image this time, and among the previously activated sites, a site that has a voice feature value greater than or equal to the smallest voice feature value of the currently activated site may participate in the splicing of the composed image this time.

S104: Fill a picture of the specified site into a sub-image of a composed image, to update the composed image in real time. In this case, sub-images in the composed image may be adjusted in real time during a conference according to a speaking condition of each site; this avoids a case in the prior art that viewable sub-images remain unchanged, and may remove an inactive site from the composed image in a timely manner and add a new active site into the composed image in a timely manner. There may be one or more sub-images in the composed image.

In this embodiment, there may be multiple manners of a step of filling a specified site into a sub-image of the composed image. It should be noted that in other embodiments of the present invention, there may further be multiple other filling manners, which are not limited in this embodiment of the present invention.

Manner A: Evenly split the composed image according to a quantity of specified sites, and fill, according to a specified sequence, the specified sites into sub-images that are obtained after the splitting. The so-called even splitting may also be referred to as even-width-and-height splitting; in other words, a quantity of times of splitting the composed image is the quantity of the specified sites minus one, and each time splitting is performed, a split window is evenly split into two. FIG. 3 shows a process during which a manner of splitting the composed image varies with a quantity of sub-images after different quantities of sites enter the composed image; when there are two images, both a width ratio and a height ratio of the sub-images are 1:1; when there are three images, a width ratio and a height ratio of the sub-images are 1:1:1 and 2:1:1, respectively; and when there are four images, both a width ratio and a height ratio of the sub-images are 1:1:1:1, and so on.

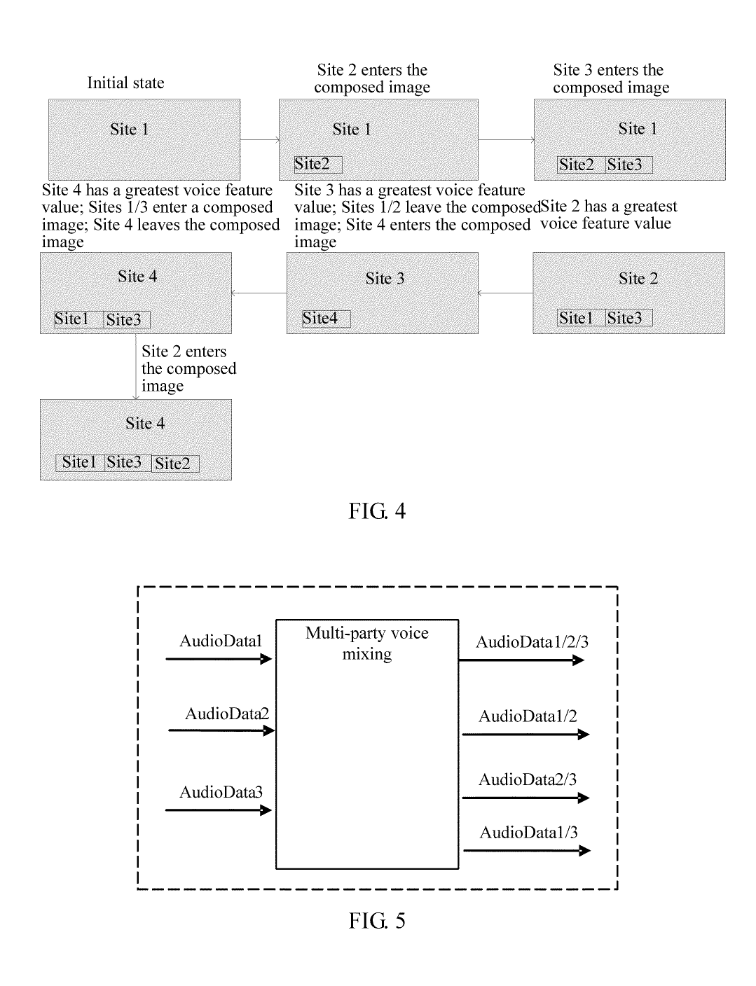

Manner B: Split the composed image according to a quantity of specified sites in a manner of embedding a small sub-image in a large sub-image, and fill, according to a specified sequence, the specified sites into sub-images that are obtained after splitting. FIG. 4 shows a process during which a manner of splitting the composed image varies with a quantity of sub-images after different quantities of sites enter the composed image. In addition, in FIG. 4, a sequence of filling large and small sub-images is displaying a site that has a greatest voice feature value as a large image, and displaying other sites as small images; for details, reference may be made to the following sequence 1.

In the foregoing manners A and B, sub-images may be different in size in some cases; accordingly, a process of filling the specified sites into the sub-images that are obtained after splitting is to perform filling according to a specified sequence, where there may be multiple specified sequences, which, preferably, may be as follows:

Sequence 1: Fill a site that has a greater voice feature value into a larger sub-image. This may enable a most active site to be displayed most noticeably.

Sequence 2: Preferentially fill historical locations in the composed image. In other words, an existing historical location is selected according to historical display location information of a site in the composed image, and a location having most historical display times is selected preferentially, so that a relative location of the site in the composed image remains unchanged, which prevents the sub-image from changing frequently and facilitates viewers' watching. In this embodiment, if historical display location information of a site 1 is X times at a location 1, Y times at a location 2, . . . , and Z times at a location N respectively, when the site 1 needs to be displayed, the historical display location times are compared, and a location having most times is selected preferentially; when a site is being displayed at this location, a location having second most times is selected; the comparison and selection are performed in turn until a display location is selected from the historical display locations; if all historical locations are occupied by sites that are being displayed, a new location except the historical locations is selected.

In addition, there may also be multiple cases that each site terminal displays the composed image: same a composed image may be displayed uniformly, where the composed image is formed by all the specified sites; or a terminal of a site that is selected as a specified site may be enabled not to display an image of the site itself For example, sites 1/2/3 are specified sites, a site terminal of the site 1 displays two sub-images, where the sub-images are the sites 2/3 respectively; a site terminal of the site 2 displays two sub-images, where the sub-images are the sites 1/3 respectively; a site terminal of the site 3 displays two images, where the sub-images are the sites 1/2 respectively; and all other sites display three images, where the sub-images are the sites 1/2/3 respectively.

In addition, in this embodiment, after step S103, the method may further include selecting a specified quantity of sites from the activated sites and performing multi-party audio mixing, and/or performing multi-party audio mixing according to a rule of not outputting voice of a site to the site itself. In the prior art, during audio mixing, normally voice of all sites are mixed; however, in this embodiment, an activated site may be determined, and therefore a range of sites for performing audio mixing may be reduced during audio mixing, thereby improving an effect of audio mixing. Two parts of rules may be included, where one is a rule of selecting a site that participates in audio mixing, in other words, selecting a specified quantity of sites from the activated sites and performing multi-party audio mixing; and the other is a rule of outputting mixed voice, in other words, performing multi-party audio mixing according to a rule of not outputting voice of a site to the site itself.

The selecting a specified quantity of sites from the activated sites and performing multi-party audio mixing may be involving all the activated sites in the audio mixing; involving all sites, in other words, M specified sites, in the composed image in the audio mixing; or setting, by a user, a maximum quantity X (for example, a value of X is 4) of sites for audio mixing, then comparing a quantity N of the activated sites with X, and if N≦X, selecting all the N activated sites and performing audio mixing, and if N>X, selecting X parties having greatest voice feature values from the N activated sites and performing audio mixing.

The rule of outputting mixed voice may be that a site in the composed image obtains voice of other sites that participate in the audio mixing, and a site not in the composed image obtains voice of all sites that participate in the audio mixing. As shown in FIG. 5, if sites 1/2/3 participate in the audio mixing, four voice signals are generated and represented as AudioData 1/2/3, AudioData 1/2, AudioData 2/3, and AudioData 1/3, respectively. Voice heard at the site 1 is AudioData 2/3; voice heard at the site 2 is AudioData 1/3; voice heard at the site 3 is AudioData 1/2; and voice heard at other sites is AudioData 1/2/3.

According to this embodiment, statistics are collected on a per-period basis; statistics are collected on some feature values that are within the period to determine whether a site is in an activated state, which is used as a basis for participating in synthesis of a composed image, thereby implementing a dynamic adjustment of content of sub-images in the composed image. This remarkably improves an effect of a conference, and significantly improves experience of participants. In addition, according to this embodiment of the present invention, a quantity and locations of sub-images in the composed image may be further adjusted dynamically, which also effectively improves the effect of the conference.

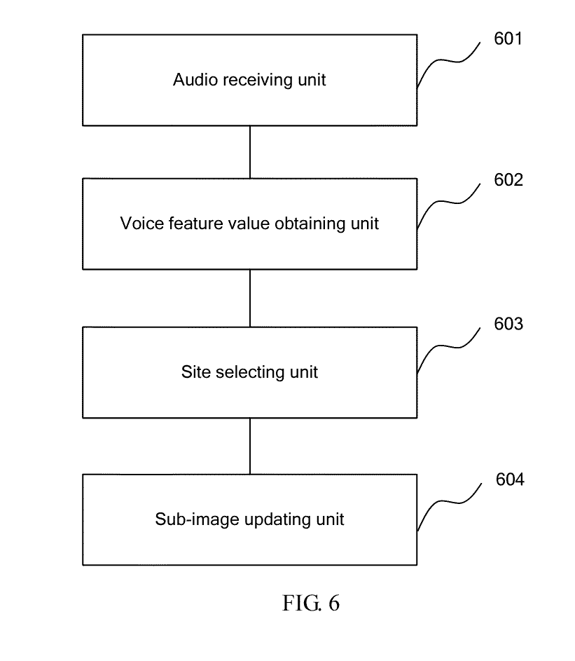

FIG. 6 is a schematic diagram of a device according to another embodiment of the present invention. The device includes an audio receiving unit 601 configured to receive audio data of a site; a voice feature value obtaining unit 602 configured to obtain, according to audio data of each site of the site and in real time, a voice feature value that is within a first specified period and of a corresponding site, where the voice feature value is used to represent an activation state of the site; a site selecting unit 603 configured to select a specified site from the multiple sites according to an activation state of each site; and a sub-image updating unit 604 configured to fill a picture of the specified site into a sub-image of a composed image, to update the composed image in real time.

The voice feature value obtaining unit includes an audio power value obtaining subunit configured to obtain an audio power value that is within the first specified period and of the corresponding site, and use the audio power value as the voice feature value; if the audio power value is greater than a specified power threshold, determine that the site is in an activated state; or a continuous voice state time length obtaining subunit configured to collect statistics on a time length in which the corresponding site is in a continuous voice state within the first specified period, and use the time length as the voice feature value; if the time length is greater than a specified time length threshold, determine that the site is in an activated state.

The audio power value obtaining subunit includes a first sampling subunit configured to select multiple second specified periods within the first specified period, and obtain audio power data of multiple sampling points within each second specified period; and a first calculating subunit configured to obtain audio power data of a second period according to a root mean square value of the audio power data of multiple sampling points, and then use an average value of audio power data of the multiple second specified periods as the audio power value.

The audio power value obtaining subunit includes a second sampling subunit configured to select multiple second specified periods within the first specified period, and then select multiple third specified periods within each second specified period; obtain audio power data of multiple sampling points within each third specified period; a second calculating subunit configured to obtain audio power data of a third period according to a root mean square value of the audio power data of multiple sampling points, and then obtain audio power data of each second specified period according to an average value of audio power data of the multiple third specified periods; and a weighting subunit configured to perform weighting on the audio power data of each second specified period and add the audio power data of each second specified period after the weighting afterwards, and use a result as the audio power value, where a rule of performing the weighting is that a greater weight is closer to a current moment.

The device embodiment is described relatively simply because it is basically similar to the method embodiment, and for portions related to those of the method embodiment, reference may be made to the description of the method embodiment.

According to this embodiment, statistics are collected on a per-period basis; statistics are collected on some feature values that are within the period to determine whether a site is in an activated state, which is used as a basis for participating in synthesis of a composed image, thereby implementing a dynamic adjustment of content of sub-images in the composed image. This remarkably improves an effect of a conference, and significantly improves experience of participants. In addition, according to this embodiment of the present invention, a quantity and locations of sub-images in the composed image may be further adjusted dynamically, which also effectively improves the effect of the conference.

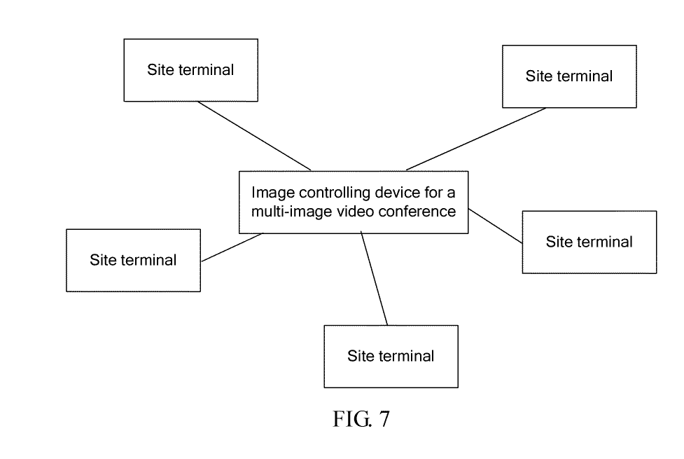

FIG. 7 is a schematic diagram of a system according to still another embodiment of the present invention, where the system includes the device according to the foregoing embodiment and one or more site terminals, where the site terminals are configured to display a composed image that is generated by the device.

The system embodiment is described relatively simply because it is basically similar to the method embodiment, and for portions related to those of the method embodiment, reference may be made to the description of the method embodiment.

According to this embodiment, statistics are collected on a per-period basis; statistics are collected on some feature values that are within the period to determine whether a site is in an activated state, which is used as a basis for participating in synthesis of a composed image, thereby implementing a dynamic adjustment of content of sub-images in the composed image. This remarkably improves an effect of a conference, and significantly improves experience of participants. In addition, according to this embodiment of the present invention, a quantity and locations of sub-images in the composed image may be further adjusted dynamically, which also effectively improves the effect of the conference.

It should be noted that in this specification, relational terms such as first and second are used only to differentiate an entity or operation from another entity or operation, and do not require or imply that any actual relationship or sequence exists between these entities or operations. Moreover, the terms “include”, “comprise”, or their any other variant is intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element proceeded by “includes a . . . ” does not, without more constraints, preclude the existence of additional identical elements in the process, method, article, or apparatus that includes the element.

A person of ordinary skill in the art may understand that all or a part of the steps of the foregoing method embodiments may be implemented by a program instructing relevant hardware. The program may be stored in a computer readable storage medium. The storage medium may include a read-only memory (ROM), a random access memory (RAM), a magnetic disk, or an optical disc.

The above are merely provided as exemplary embodiments of the present invention, but are not intended to limit the protection scope of the present invention. Specific examples are used in this specification to elaborate the principles and implementation mode of the present invention. The above embodiments are merely for facilitating the understanding of the method and core idea of the present invention. In addition, it is readily apparent for a person of ordinary skill in the art to derive alternatives and variations on specific implementation modes and application scope according to the idea of the present invention. In conclusion, the disclosure of the specification shall not be understood as a limitation to the present invention. Any modification, equivalent replacement, and improvement made within the spirit and principle of the present invention shall all fall within the protection scope of the present invention.

What is claimed is:

1. An image controlling method for a composed-image video conference, the method comprising:
receiving audio data of sites;
obtaining, according to the audio data of each site and in real time, a voice feature value that is within a first specified period and of a corresponding site, wherein the voice feature value is used to represent an activation state of the site;
selecting a specified site from the sites according to the activation state of each site; and
filling a picture of the specified site into a sub-image of a composed image to update the composed image in real time.

2. The method according to claim 1, wherein obtaining the voice feature value that is within the first specified period and of the corresponding site comprises:
obtaining an audio power value that is within the first specified period and of the corresponding site;
using the audio power value as the voice feature value; and
determining that the site is in an activated state when the audio power value is greater than a specified power threshold.

3. The method according to claim 2, wherein obtaining the audio power value that is within the first specified period and of the corresponding site further comprises:
selecting multiple second specified periods within the first specified period;
obtaining audio power data of multiple sampling points within each second specified period;
obtaining audio power data of a second specified period according to a root mean square value of the audio power data of multiple sampling points; and
using an average value of audio power data of the multiple second specified periods as the audio power value.

4. The method according to claim 2, wherein obtaining the audio power value that is within the first specified period and of the corresponding site further comprises:
selecting multiple second specified periods within the first specified period;
selecting multiple third specified periods within each second specified period;
obtaining audio power data of multiple sampling points within each third specified period;
obtaining audio power data of a third specified period according to a root mean square value of the audio power data of multiple sampling points;
obtaining audio power data of each second specified period according to an average value of audio power data of the multiple third specified periods;
performing weighting on the audio power data of each second specified period;
adding the audio power data of each second specified period after the weighting afterwards; and
using a result as the audio power value, wherein a rule of performing the weighting is that a greater weight is closer to a current moment.

5. The method according to claim 1, wherein obtaining the voice feature value that is within the first specified period and of the corresponding site comprises:
collecting statistics on a time length in which the corresponding site is in a continuous voice state within the first specified period;
using the time length as the voice feature value; and
determining that the site is in an activated state when the time length is greater than a specified time length threshold.

6. The method according to claim 1, wherein obtaining the voice feature value that is within the first specified period and of the corresponding site comprises:
obtaining an audio power value and a continuous voice state time length that are within the first specified period and of the corresponding site;
using a combination of the audio power value and the time length as the voice feature value; and
determining that the site is in an activated state when the combination meets a specified rule.

7. The method according to claim 1, wherein selecting the specified site from the multiple sites according to the activation state of each site comprises using a site that is currently in an activated state as the specified site.

8. The method according to claim 1, wherein selecting the specified site from the multiple sites according to the activation state of each site comprises using both a site that was previously in an activated state and a site that is currently in an activated state as specified sites.

9. The method according to claim 1, wherein selecting the specified site from the multiple sites according to the activation state of each site comprises using a site that is currently in an activated state, and a site that was previously in an activated state and has a voice feature value greater than a smallest value of the voice feature value of the site that is currently in the activated state, as specified sites.

10. The method according to claim 1, wherein filling the picture of the specified site into the sub-image of the composed image comprises:
evenly splitting the composed image according to a quantity of specified sites; and
filling, according to a specified sequence, the specified sites into sub-images that are obtained after splitting.

11. The method according to claim 10, wherein the specified sequence is a sequence of filling a site that has a greater voice feature value into a larger sub-image.

12. The method according to claim 10, wherein the specified sequence is a sequence, according to which the specified sites are preferentially filled into historical locations that are in the composed image.

13. The method according to claim 1, wherein filling the picture of the specified site into the sub-image of the composed image comprises:
splitting the composed image according to a quantity of specified sites in a manner of embedding a small sub-image in a large sub-image; and
filling, according to a specified sequence, the specified sites into sub-images that are obtained after splitting.

14. The method according to claim 1, wherein after selecting the specified site from the multiple sites according to the activation state of each site, the method further comprises at least one of the following:
selecting a specified quantity of sites from activated sites and performing multi-party audio mixing; and
performing multi-party audio mixing according to a rule of not outputting voice of a site to the site itself.

15. An image controlling device for a composed-image video conference, wherein the device comprises:
an audio receiving unit configured to receive audio data of sites;
a voice feature value obtaining unit configured to obtain, according to the audio data of each site and in real time, a voice feature value that is within a first specified period and of a corresponding site, wherein the voice feature value is used to represent an activation state of the site;
a site selecting unit configured to select a specified site from the multiple sites according to the activation state of each site; and
a sub-image updating unit configured to fill a picture of the specified site into a sub-image of a composed image to update the composed image in real time.

16. The device according to claim 15, wherein the voice feature value obtaining unit comprises an audio power value obtaining subunit configured to:
obtain an audio power value that is within the first specified period and of the corresponding site;
use the audio power value as the voice feature value; and
determine that the site is in an activated state if the audio power value is greater than a specified power threshold.

17. The device according to claim 16, wherein the audio power value obtaining subunit comprises:
a first sampling subunit configured to select multiple second specified periods within the first specified period, and obtain audio power data of multiple sampling points within each second specified period; and
a first calculating subunit configured to obtain audio power data of a second period according to a root mean square value of the audio power data of multiple sampling points, and use an average value of audio power data of the multiple second specified periods as the audio power value.

18. The device according to claim 16, wherein the audio power value obtaining subunit comprises:
a second sampling subunit configured to select multiple second specified periods within the first specified period, select multiple third specified periods within each second specified period, and obtain audio power data of multiple sampling points within each third specified period;
a second calculating subunit configured to obtain audio power data of a third period according to a root mean square value of the audio power data of multiple sampling points, and obtain audio power data of each second specified period according to an average value of audio power data of the multiple third specified periods; and
a weighting subunit configured to perform weighting on the audio power data of each second specified period, add the audio power data of each second specified period after the weighting afterwards, and use a result as the audio power value, wherein a rule of performing the weighting is that a greater weight is closer to a current moment.

19. The device according to claim 15, wherein the voice feature value obtaining unit comprises a continuous voice state time length obtaining subunit configured to:
collect statistics on a time length in which the corresponding site is in a continuous voice state within the first specified period;
use the time length as the voice feature value; and
determine that the site is in an activated state if the time length is greater than a specified time length threshold.

20. An image controlling system for a composed-image video conference, wherein the system comprises an image controlling device and one or more site terminals, wherein the image controlling device is configured to:
receive audio data of sites;
obtain, according to the audio data of each site and in real time, a voice feature value that is within a first specified period and of a corresponding site, wherein the voice feature value is used to represent an activation state of the site;
select a specified site from the sites according to an activation state of each site; and
fill a picture of the specified site into a sub-image of a composed image to update the composed image in real time, wherein the site terminals are configured to display the composed image that is generated under control of the image controlling device.
